(19) United States
(12) Patent Application Publication
(10) Pub. No.: US 2022/0388042 A1
(43) Pub. Date: Dec. 8, 2022

(54) MODULAR DECOKING ASSEMBLY

(71) Applicant: Quest Integrity Group, LLC, Sugar Land, TX (US)

(72) Inventor: Maarten Cornelis BURGGRAAFF, Tricht (NL)

(21) Appl. No.: 17/775,484

(22) PCT Filed: Nov. 16, 2020
(86) PCT No.: PCT/US2020/060708

§ 371 Date: May 9, 2022

Related U.S. Application Data
(60) Provisional application No. 62/936,017, filed on Nov. 15, 2019.

(51) Int. Cl. B08B 9/055; F16L 55/38

(52) U.S. Cl. CPC B08B 9/0551; F16L 55/38

(57) ABSTRACT

A modular decoking assembly with a transportable container and multiple prefabricated modules that can be installed within the transportable container, and methods of forming a decoking unit with a plurality of prefabricated modules within a container.

### CROSS-REFERENCE TO RELATED APPLICATIONS

This application claims priority to U.S. Provisional Patent Application Ser. No. 62/936,017, filed Nov. 15, 2019, entitled “Modular Decoking Unit,” which is incorporated herein by reference.

### FIELD

This application relates to a modular decoking assembly, specifically to methods and devices that support a modular construction and utilization of decoking units.

### BACKGROUND

Pipeline and tubing can become less efficient over time due to exposure to harsh chemicals that can create scale and coke within the pipeline or tubing. This buildup of scale and coke can lead to inefficiencies in the plants and refineries such as reduced process output, higher costs, greater environmental harm and pollutants, and a reduced life of the pipeline or tubing, especially in petrochemical plants and refineries that utilize fired heaters. To avoid these issues and maintain peak efficiency of the plants and refineries, the pipeline or tubing require regular cleaning and monitoring. One method of doing so is mechanical decoking.

Mechanical decoking is the process of passing a device called a pig through tubing or pipelines for cleaning and inspection purposes. The pig is propelled through a pipeline or tubing, and the pig can then execute certain activities inside the pipeline or tubing such as cleaning, inspecting, monitoring, and reporting the conditions within the pipeline or tubing.

One method of propelling the pig through the pipeline or tubing is with a liquid propellant, such as water, cleaning solution, or product. Sufficient pressure to propel the pig through the pipeline or tubing can be achieved with a liquid circuit comprising a launcher and a receiver attached at opposite ends of the tubing and an external pigging unit to create and control the fluid pressure within the system.

The equipment required for mechanical decoking typically must be customized to meet the specific needs of a project. Traditionally, manufacturing decoking units has been a long and arduous process taking substantial time, for instance up to a year. For custom projects, manufacturers have to complete jobs in series, meaning one after the other, due to various regulations and requirements for building this highly specialized equipment. An entire decoking unit would need to be finished before starting construction on another. The ability to outsource or complete jobs in parallel is difficult. Thus, manufacturers of this equipment are limited by how quickly they can complete a decoking unit and typically struggle to meet the demand from clients.

In addition, certain regulations may prevent transportation of fully assembled decoking units overseas. Because the decoking technologies will regularly come into contact with aggressive and corrosive chemicals, the various parts of decoking units may need to be made of different materials, depending on the types of chemicals each unit comes into contact with. However, transporting a fully assembled decoking unit with parts of differing materials can conflict with various governmental regulations. For example, Lloyd's Register prevents transporting units that have welded stainless steel to carbon steel.

Moreover, the transportation of decoking units in general can be difficult. Many mobile decoking units provide certain benefits but impede the overall process in others. In addition, the overall arrangement of various parts on a decoking unit are geared more towards short-term efficiency of the project rather than the long-term safety of operators of the equipment. There can be a struggle to marry the client's demands for efficiency of the technology with the safety of those operating the equipment.

Prior attempts to solve the above listed problems have been inefficient, forcing the burdened plants and refineries to compromise efficiency and safety or to forego mechanical decoking processes altogether. However, mechanical decoking remains a highly efficient method of cleaning and inspecting pipeline and tubing, and various spatial and regulatory constraints do not negate the need for regular maintenance of these systems.

Therefore, a need exists for a decoking assembly that allows a greater deal of customization and accommodations for clients with different needs without compromising the safety and efficiency of the mechanical decoking process.

### SUMMARY

This summary is provided to introduce a selection of concepts that are further described below in the detailed description. However, many modifications are possible without materially departing from the teachings of this disclosure. Accordingly, such modifications are intended to be included within the scope of this disclosure as defined in the claims. This summary is not intended to identify key or essential features of the claimed subject matter, nor is it intended to be used as an aid in limiting the scope of the claimed subject matter.

Devices and methods to form a decoking unit are described herein. Embodiments may include providing a plurality of prefabricated modules; providing a container capable of housing the prefabricated modules; and installing the prefabricated modules in the container.

One or more embodiments may include the method of the preceding paragraph, wherein the prefabricated modules are demountable from the container. Using prefabricated modular units solves both the issue of manufacturing, as the prefabricated modules may be created by various manufacturers in parallel as needed, as well as the issue of regulations and import/export issues as each module may be manufactured and shipped within existing regulations and assembled at a later date as needed dependent upon the circumstances of the mechanical decoking process. The modular units also allow for safer and more manageable transportation options.

One or more embodiments may include the method of any preceding paragraph, wherein at least one of the prefabricated modules is a collection tank comprising at least one collection reservoir; at least one pipe capable of expelling dirty fluid into the at least one collection reservoir during a mechanical decoking operation; at least one collection basket capable of filtering out solid coke deposits from the dirty fluid; and a plurality of attachment surfaces that allow for nonpermanent attachment of the collection tank to the container.

One or more embodiments may include the method of any preceding paragraph, wherein the collection tank is stainless steel.

Modular decoking assemblies are described herein. Embodiments may include a transportable container with a plurality of internal structures defining at least one compartment within the container; and a plurality of prefabricated modules capable of mounting within the transportable container.

One or more embodiments may include the device of any preceding paragraph, wherein the plurality of prefabricated modules comprise at least one motorized pigging unit; at least one collection tank; at least one fuel source; and at least one tooling box.

One or more embodiments may include the device of any preceding paragraph, wherein the plurality of compartments comprise at least one recess for a pigging unit; at least one recess for a collection tank; and at least one recess for a control room.

One or more embodiments may include the device for any preceding paragraph, wherein the plurality of compartments comprise at least one recess for a pigging unit; at least one recess for a collection tank; and at least one recess for an engine room.

One or more embodiments may include the device of any preceding paragraph, wherein a control valve may be installed with at least one of the prefabricated modules.

One or more embodiments may include the device of any preceding paragraph, wherein a flow control valve may be installed with at least one of the prefabricated modules.

Methods of transporting decoking units are described herein. Embodiments may include a tractor unit; a semi-trailer attached to the tractor unit; a control room mounted on the semi-trailer; and a decoking unit mounted on the semi-trailer.

One or more embodiments may include the method of any preceding paragraph, wherein the decoking unit comprises a transportable container with a plurality of internal structures defining at least one compartment within the container; and a plurality of prefabricated modules capable of mounting within the transportable container.

### BRIEF DESCRIPTION OF DRAWINGS

Certain embodiments of the disclosure will hereafter be described with reference to the accompanying drawings, wherein like reference numerals denote like elements. It is emphasized that, in accordance with standard practices in the industry, various features are not drawn to scale. In fact, the dimensions of various features may be arbitrarily increased or reduced for clarity of discussion. It should be understood, however, that the accompanying figures illustrate the various implementations described herein and are not meant to limit the scope of various technologies described herein.

FIG. 1 illustrates an exploded view of an embodiment of the present disclosure with certain selected prefabricated modules.

FIG. 2 illustrates a perspective view of an embodiment of the present disclosure with certain selected prefabricated modules installed within the container.

FIG. 3 illustrates a top perspective view of a demountable collection tank.

FIGS. 4A through 4D illustrate various perspective views of a demountable collection tank.

FIGS. 5A through 5B illustrate various views of a transportation unit for a decoking apparatus.

### DETAILED DESCRIPTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases, it will be recognized that references to the “invention” will refer to subject matter recited in one or more, but not necessarily all, of the claims. Each of the inventions will now be described in greater detail below, including specific embodiments, versions, and examples, but the inventions are not limited to these embodiments, versions, or examples, which are included to enable a person having ordinary skill in the art to make and use the inventions when the information in this patent is combined with available information and technology.

Various terms as used herein are shown below. To the extent a term used in a claim is not defined below, it should be given the broadest definition skilled persons in the pertinent art have given that term as reflected in printed publications and issued patents at the time of filing. Further, unless otherwise specified, all compounds described herein may be substituted or unsubstituted and the listing of compounds includes derivatives thereof.

Further, various ranges and/or numerical limitations may be expressly stated below. It should be recognized that unless stated otherwise, it is intended that endpoints are to be interchangeable. Further, any ranges include iterative ranges of like magnitude falling within the expressly stated ranges or limitations.

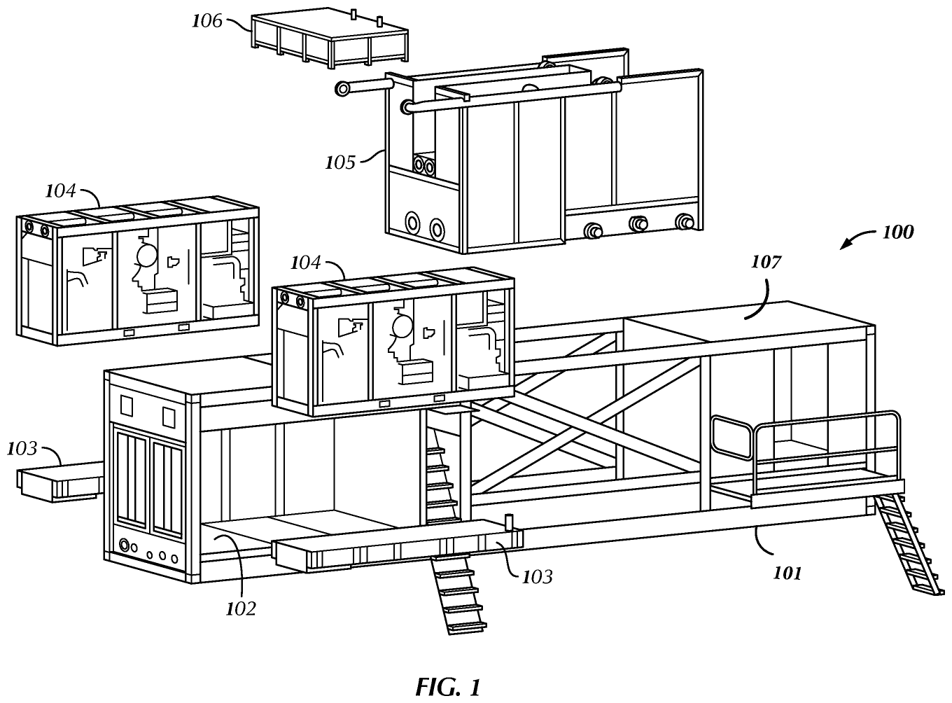

FIG. 1 illustrates an exploded view of a modular decoking assembly 100. The container 101 has various compartments 102 that can house prefabricated modules needed to carry out the decoking process. These compartments 102 are each defined by internal structures that are made to fit the prefabricated module or modules the compartment 102 will house. The indicated compartment 102 is designed to fit two pigging units 104 and two fuel sources 103, with each pigging unit 104 sitting atop a fuel source 103. Thus, the internal structures of compartment 102 complement the shown pigging units 104 and fuel sources 103 such that the pigging unit 104 may sit atop the fuel source 103 within the confines of compartment 102.

The selected prefabricated modules in this embodiment are a collection tank 105, a tooling box 106, two pigging units 104, and two fuel sources 103. There is also space for a control room 107 at the end of the container 101. However, the prefabricated modules may be different than those shown and customized based upon the particular needs of a job. In another embodiment, an engine could be installed within a compartment 102, and the control room 107 could be separate from the entire container 101. The container 101 could also be limited to one compartment 102 designed to hold a set of prefabricated modules. This single compartment 102 could be beneficial for projects with strict spatial constraints that need a pigging unit 104 and fuel source 103 separate from the collection tank 105 and tooling box 106, with an external driver to allow for arrangement of the modules to fit the job site's spatial constraints.

Each prefabricated module may be manufactured in parallel, meaning the modules may be manufactured individually and then later installed within a container. Manufacturing the modules in parallel allows a manufacturer to work ahead and make various modules in anticipation of future orders. The manufacturer may also outsource many of the manufacturing activities or have them take place side-by-side, thus greatly reducing overall manufacturing times.

When using the modular decoking assembly, the prefabricated modules can also be made demountable. For purposes of this application, demountable should be understood by those having ordinary skill in the art to mean removable from its setting. Thus, prefabricated modules that are demountable from the container 101 can be removed from the container 101 as needed for transport, repair, maintenance, replacement, or to comply with various regulations or requirements from regulatory bodies or clients. While certain modules may be demountable, others may still be welded to the container for safety or practical purposes. For example, a prefabricated module may be welded to the container to cut down on loud noises and vibrations that may arise if a module is mounted within the container rather than welded.

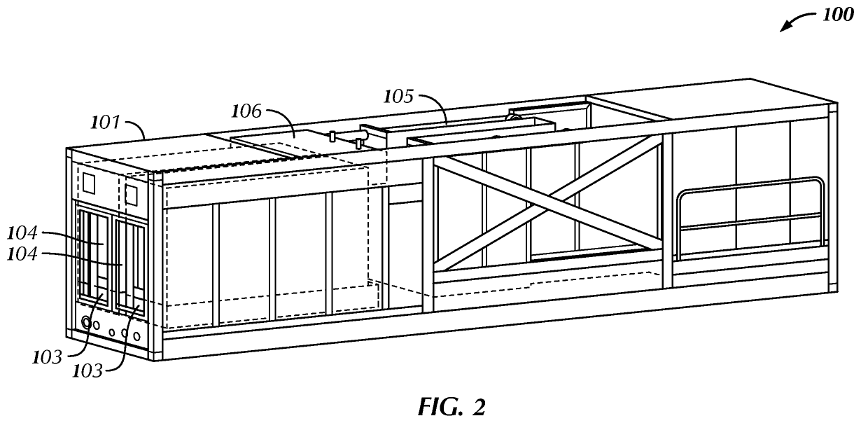

FIG. 2 illustrates a perspective view of an assembled decoking unit. The prefabricated modules are installed within the container 101 in complementary compartments 102. This view provides perspective on where each module fits within the container 101, and how the internal structures within the compartments 102 complement the prefabricated modules. The fuel sources 103 are installed beneath the pigging units 104. The collection tank 105 is also installed substantially in the center of the decoking unit with the tooling box 106 installed between the pigging units 104 and the collection tank 105.

In a preferred embodiment, each of these modules may be removed from the container 101 and overall assembly for repair or maintenance services as needed. However, still other embodiments may require welding of one or more of the prefabricated modules with the container 101, thus not allowing for the removal of the modules after initial assembly.

The container 101 is not completely enclosed. Rather, the modules may be accessed while within the container 101 using various openings, windows, doors, and access holes built into the container 101. These openings, windows, doors, and access holes make up the external shell of the container and are customized based upon the prefabricated modules that will be inserted within the container 101. For example, there are access holes built into the container 101 where the pigging units 104 are located. This allows for hoses to be connected while the pigging unit 104 is within the container 101 to allow operation of the pigging units 104. Further, the container 101 leaves an open space above the collection tank to allow for the proper operation of the mechanical decoking process.

The container 101 is transportable in this construction as an entire unit. Certain prefabricated modules may be removed during transport and installed at the job site, if required by job site or governing regulations.

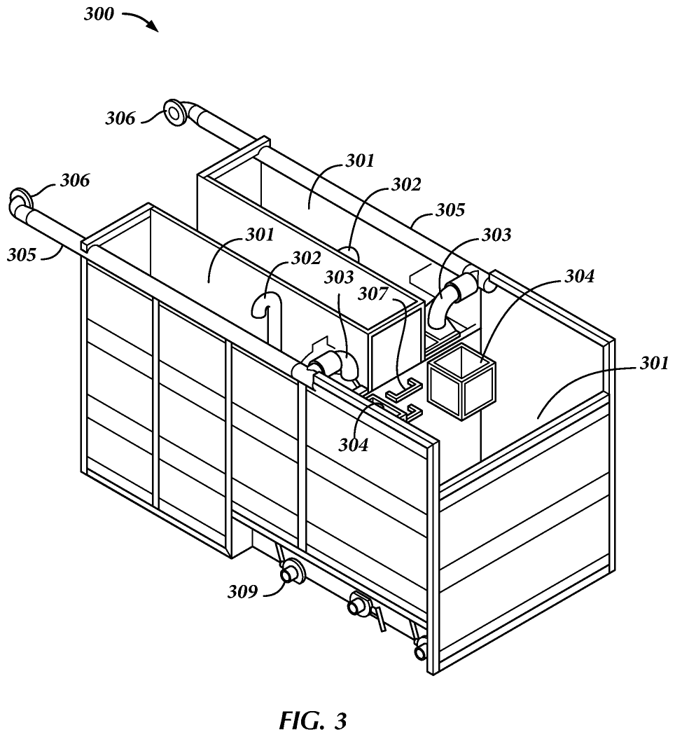

FIG. 3 illustrates a top perspective view of a demountable collection tank 300. In certain embodiments, this demountable collection tank 300 is the same as the prefabricated module collection tank 105 in FIG. 1. The collection tank 300 is mounted within a container 101 and attached to one or more pigging units with a nonpermanent attachment. When connected to a decoking unit, dirty fluid can enter the collection tank 300 through the fluid source attachments 306. This collection tank 300 is designed for a two pump system, thus two fluid source attachments 306 are shown. However, a one pump, three pump, or four pump collection tank could also be utilized in the present disclosure.

The dirty fluid travels through the dirty fluid channel 305 to the dirty fluid expeller 303. The dirty fluid can then be passed through a collection basket 304 into the fluid reservoir 301 to catch any solid coke deposits from the mechanical decoking process to help ensure that only dirty fluid flows to the designated collection point. An overflow pipe 302 may be installed within the collection tank 300 as well. The fluid reservoir 301 and collection basket 304 can later be accessed by way of an access point, such as a ladder 307, to remove any solid coke deposits. The dirty fluid can then flow to a designated collection point by way of the dump valves 309 on the side of the collection tank 300.

The collection tank 300 is considered demountable because a user could remove the collection tank 300 from a larger container as needed for repair, inspection, or servicing. It is not welded to the larger container. Thus, if a user prefers a stainless steel collection tank to better resist the corrosive chemicals and coke deposits of the mechanical decoking process, but wants the remainder of the materials or container to be of a different material such as carbon steel, the user could do so without conflicting with Lloyd's Register requirements against welding a stainless steel collection tank to a carbon steel structure.

The collection tank 300 has multiple attachment surfaces that allow for placement of the collection tank 300 within a larger storage container. There are also areas where the reservoir may be lifted using a crane or similar device and situated within a storage container. The storage container in which the collection tank 300 is installed may be a high cube container or a standard storage container, depending on the specific needs of a project.

In a preferred embodiment of the present disclosure, the collection tank 300 is constructed of stainless steel to withstand the aggressive chemicals associated with the decoking process. However, in other embodiments the collection tank 300 can be constructed of carbon steel, alloy steel, tool steel, a composite of these materials with or without stainless steel, or any other material that can withstand the pressure and corrosive chemicals involved in the decoking process. The collection tank 300 may also be further treated to withstand the chemicals.

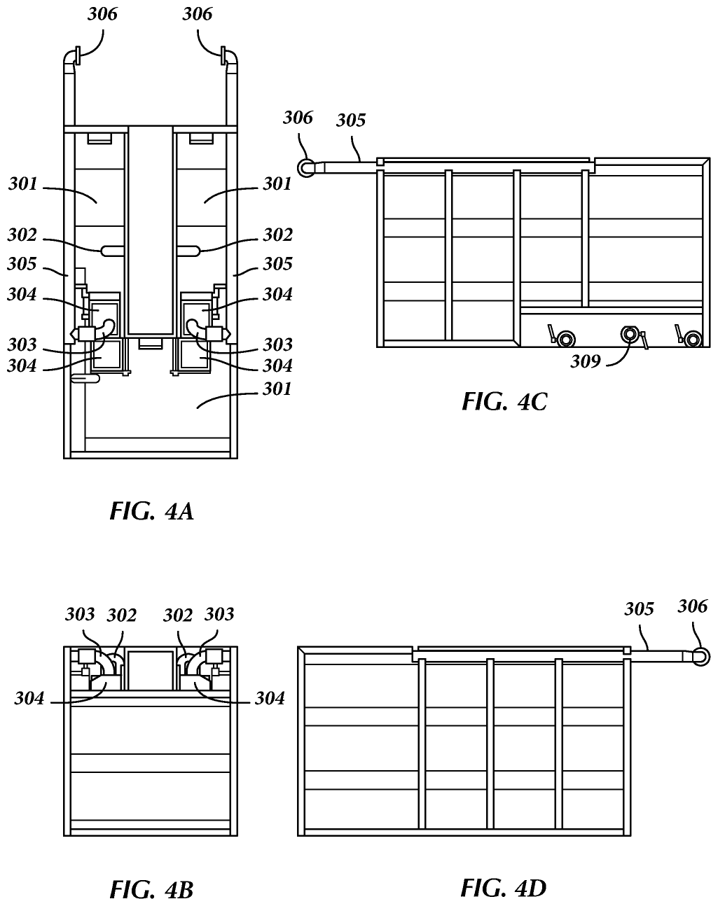

FIGS. 4A through 4D illustrate various perspective views of the demountable collection tank 300. These additional figures are provided to demonstrate the configuration of the various elements of the demountable collection tank in relation to one another. FIG. 4A is a top perspective view. FIG. 4B is a front perspective view. FIGS. 4C and 4D are side perspective views demonstrating the dump valves 309. While the dump valves 309 are shown on only one side in this figure, in certain other embodiments the dump valves could be on the other side of the collection tank 300, present on both sides of the collection tank 300, or present on the front or back of the collection tank 300. Further, more than three or less than three dump valves 309 may be present, depending on the particular needs and function of the collection tank.

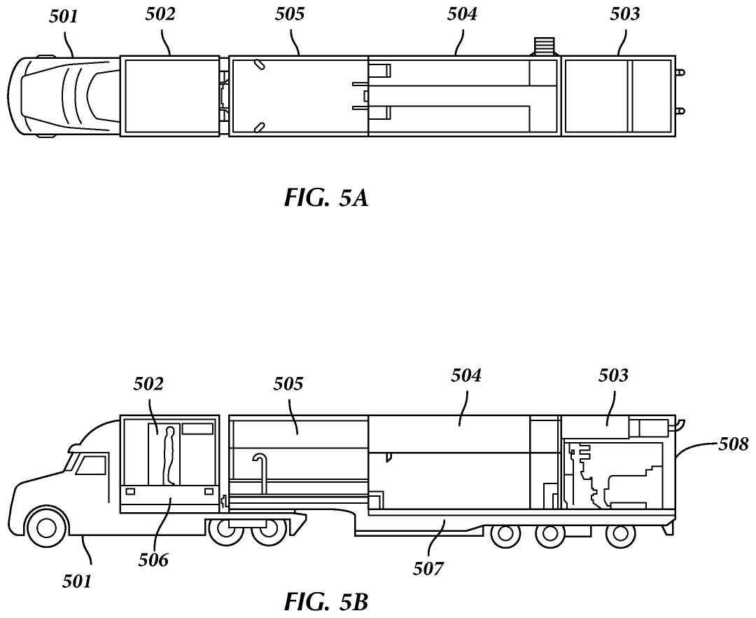

FIGS. 5A through 5B illustrate various views of a transportation unit for a decoking container. This transportation unit allows for the transportation of decoking equipment, as well as the safer operation of the entire decoking unit while the container and control room 502 are still mounted on the transportation unit. Specifically, the control room 502 is connected to the tractor unit 501 of the transportation unit either by welding or mounting. The container with various prefabricated modules is mounted on the semi-trailer 507. The prefabricated modules demonstrated here are a dirty fluid collection tank 505, a clean fluid tank 504, a pigging unit 508, and an engine compartment 503. In certain embodiments, a storage compartment 506 may also be present under the control room 502 on the tractor unit 501.

Placing the control room 502 on the tractor unit 501 instead of the semi-trailer 507 provides a safer work environment for those within the control room. The loud noises and strong vibrations generated by the decoking equipment can be magnified when the control room 502 is on the semi-trailer 507 with the rest of the decoking equipment. However, placing the control room 502 on the tractor unit helps to lessen the dangerous and uncomfortable work conditions for unit operators. In this way, all of the decoking equipment can still be centralized on one transportation unit, and carried out on the same transportation unit, thus yielding the desired efficiency of the process, while still having a safer decoking procedure overall.

While the present disclosure is useful with the type of tubing in oil refineries and petrochemical plants that carry hydrocarbons subject to high temperatures, this apparatus and method may also be used with other types of pipes and tubing, especially applications that require a hydraulic pressure system.

While various devices and methods have been described above in connection with several illustrative embodiments, it is to be understood that other similar embodiments may be used or modified, and additions may be made to the described embodiments for performing the same function disclosed herein without deviating therefrom.

Further, all embodiments disclosed are not necessarily in the alternative, as various embodiments may be combined or subtracted to provide the desired characteristics. Variations can be made by one having ordinary skill in the art without departing from the spirit and scope hereof. The scope of the present disclosure is determined by the claims that follow.

What is claimed is:

1. A method of forming a decoking unit comprising:
providing a plurality of prefabricated modules;
providing a container capable of housing the prefabricated modules; and
installing the prefabricated modules in the container.

2. The method of claim 1, wherein the prefabricated modules are demountable from the container.

3. The method of claim 1, wherein at least one of the prefabricated modules is a collection tank comprising:
at least one fluid reservoir;
at least one pipe capable of expelling dirty fluid during a mechanical decoking operation;
at least one collection basket capable of filtering out solid coke deposits from the dirty fluid; and
a plurality of attachment surfaces that allow for nonpermanent attachment of the collection tank to the container.

4. The method of claim 3, wherein the collection tank is stainless steel.

5. A modular decoking assembly, comprising:
a transportable container with a plurality of internal structures defining at least one compartment within the transportable container; and
a plurality of prefabricated modules capable of mounting within the transportable container.

6. The modular decoking assembly of claim 5, wherein the plurality of prefabricated modules comprise:
at least one motorized pigging unit;
at least one collection tank;
at least one fuel source; and
at least one tooling box.

7. The modular decoking assembly of claim 5, wherein the plurality of compartments comprise:
at least one recess for a pigging unit;
at least one recess for a collection tank; and
at least one recess for a control room.

8. The modular decoking assembly of claim 5, wherein the plurality of compartments comprise:
at least one recess for a pigging unit;
at least one recess for a collection tank; and
at least one recess for an engine compartment.

9. The assembly of claim 5, wherein a pressure control valve may be installed with at least one of the prefabricated modules.

10. The assembly of claim 5, wherein a flow control valve may be installed with at least one of the prefabricated modules.

11. An assembly for transporting decoking equipment comprising:
a tractor unit;
a semi-trailer attached to the tractor unit;
a control room mounted on the tractor unit; and
a decoking unit mounted on the semi-trailer.

12. The assembly of claim 11, wherein the decoking unit comprises:
a transportable container with a plurality of internal structures defining at least one compartment within the transportable container; and
a plurality of prefabricated modules capable of mounting within the transportable container.
